(19) United States
(12) Patent Application Publication
(10) Pub. No.: US 2023/0034816 A1
(43) Pub. Date: Feb. 2, 2023

(54) ANTENNA, WIRELESS COMMUNICATION MODULE, AND WIRELESS COMMUNICATION DEVICE

(71) Applicant: KYOCERA CORPORATION, Kyoto-shi, Kyoto (JP)

(72) Inventors: Hiroshi UCHIMURA, Kagoshima-shi, Kagoshima (JP); Hiromichi YOSHIKAWA, Yokohama-shi, Kanagawa (JP); Yuuki NAKAYAMA, Kirishima-shi, Kagoshima (JP); Hikaru NEKOZUKA, Yokohama-shi, Kanagawa (JP); Kouichi MARUTA, Kirishima-shi, Kagoshima (JP); Sunao HASHIMOTO, Yokohama-shi, Kanagawa (JP)

(21) Appl. No.: 17/788,724

(22) PCT Filed: Dec. 21, 2020
(86) PCT No.: PCT/JP2020/047743

§ 371 Date: Jun. 23, 2022

(30) Foreign Application Priority Data
Dec. 26, 2019 (JP) 2019-237340

(51) Int. Cl. H01Q 9/28; H01Q 1/24; H01Q 1/38; H01Q 1/27

(52) U.S. Cl. CPC H01Q 9/28; H01Q 1/241; H01Q 1/38; H01Q 1/273

(57) ABSTRACT

Provided is a novel antenna, wireless communication module, and wireless communication device. The antenna includes a first conductor, a second conductor, a third conductor, a fourth conductor, and a feed line. The second conductor faces the first conductor in a first direction. The third conductor is along the first direction, located between the first conductor and the second conductor, and configured to capacitively connect the first conductor and the second conductor. The fourth conductor is along the first direction, separated from the third conductor in a second direction intersecting the first direction, and electrically connected to the first conductor and the second conductor. The feed line is electrically connected to the third conductor. The antenna is bending deformable in cross-sectional views along the first direction and the second direction.

### TECHNICAL FIELD

The present disclosure relates to an antenna, a wireless communication module, and a wireless communication device.

### BACKGROUND ART

Electromagnetic waves emitted from an antenna are reflected by a metal conductor. A 180° phase shift occurs in the electromagnetic waves reflected by the metal conductor. The reflected electromagnetic waves combine with the electromagnetic waves emitted from the antenna. The electromagnetic waves emitted from the antenna may decrease in amplitude by combining with the phase-shifted electromagnetic waves. As a result, the amplitude of the electromagnetic waves emitted from the antenna decreases. The effect of the reflected waves is reduced by the distance between the antenna and the metal conductor being set to ¼ of the wavelength λ of the emitted electromagnetic waves.

In contrast, a technique for reducing the effect of reflected waves using an artificial magnetic wall has been proposed. This technology is described, for example, in Non-Patent Literature (NPL) 1 and 2.

### CITATION LIST

### Non-Patent Literature

NPL 1: Murakami et al., “Low-Profile Design and Bandwidth Characteristics of Artificial Magnetic Conductor with Dielectric Substrate”, IEICE Transactions on Communications (B), Vol. J98-B No. 2, pp. 172-179
NPL 2: Murakami et al., “Optimum Configuration of Reflector for Dipole Antenna with AMC Reflector”, IEICE Transactions on Communications (B), Vol. J98-B No. 11, pp. 1212-1220

### SUMMARY OF INVENTION

### Technical Problem

However, the techniques described in NPL 1 and 2 require a large number of resonator structures to be aligned.

The present disclosure is directed at providing a novel antenna, wireless communication module, and wireless communication device.

### Solution to Problem

An antenna according to an embodiment of the present disclosure includes a first conductor, a second conductor, a third conductor, a fourth conductor, and a feed line. The second conductor faces the first conductor in a first direction. The third conductor is along the first direction, is located between the first conductor and the second conductor, and capacitively connects the first conductor and the second conductor. The fourth conductor is along the first direction, is separated from the third conductor in a second direction intersecting the first direction, and is electrically connected to the first conductor and the second conductor. The feed line is electromagnetically connected to the third conductor. The antenna is bending deformable in cross-sectional views along the first direction and the second direction.

An antenna according to an embodiment of the present disclosure includes a first conductor, a second conductor, a third conductor, a fourth conductor, and a feed line. The second conductor faces the first conductor in a first direction. The third conductor is along the first direction, is located between the first conductor and the second conductor, and capacitively connects the first conductor and the second conductor. The fourth conductor is along the first direction, is separated from the third conductor in a second direction intersecting the first direction, and is electrically connected to the first conductor and the second conductor. The feed line is electromagnetically connected to the third conductor. The first direction is along a curve.

A wireless communication module according to an embodiment of the present disclosure includes the antenna described above and a Radio Frequency (RF) module. The RF module is electrically connected to the feed line.

A wireless communication device according to an embodiment of the present disclosure includes the wireless communication module described above and a battery. The battery supplies electrical power to the wireless communication module.

### Advantageous Effects of Invention

An embodiment of the present disclosure can provide a novel antenna, wireless communication module, and wireless communication device.

### BRIEF DESCRIPTION OF DRAWINGS

FIG. 1 is a perspective view of an antenna according to an embodiment of the present disclosure.

FIG. 2 is a cross-sectional view of the antenna taken along a line L1-L1 illustrated in FIG. 1.

FIG. 3 is a cross-sectional view of an antenna according to another embodiment of the present disclosure.

FIG. 4 is a cross-sectional view of the antenna taken along a line L2-L2 illustrated in FIG. 3.

FIG. 5 is a cross-sectional view of an antenna according to yet another embodiment of the present disclosure.

FIG. 6 is a cross-sectional view of the antenna taken along a line L3-L3 illustrated in FIG. 5.

FIG. 7 is a diagram illustrating an arrangement of an antenna according to an embodiment of the present disclosure.

FIG. 8 is a diagram illustrating an arrangement of an antenna according to another embodiment of the present disclosure.

FIG. 9 is a diagram illustrating an arrangement of an antenna according to yet another embodiment of the present disclosure.

FIG. 10 is a diagram illustrating an arrangement of an antenna according to yet another embodiment of the present disclosure.

FIG. 11 is a diagram illustrating an arrangement of an antenna according to yet another embodiment of the present disclosure.

FIG. 12 is a block diagram of a wireless communication module according to an embodiment of the present disclosure.

FIG. 13 is a schematic configuration diagram of the wireless communication module illustrated in FIG. 12.

FIG. 14 is a block diagram of a wireless communication device according to an embodiment of the present disclosure.

FIG. 15 is a plan view of the wireless communication device illustrated in FIG. 14.

FIG. 16 is a cross-sectional view of the wireless communication device illustrated in FIG. 14.

### DESCRIPTION OF EMBODIMENTS

In the present disclosure, a “dielectric material” may include a composition of either a ceramic material or a resin material. Examples of the ceramic material include an aluminum oxide sintered body, an aluminum nitride sintered body, a mullite sintered body, a glass ceramic sintered body, a crystallized glass yielded by precipitation of a crystal component in a glass base material, and a microcrystalline sintered body such as mica or aluminum titanate. Examples of the resin material include an epoxy resin, a polyester resin, a polyimide resin, a polyamide-imide resin, a polyetherimide resin, and a resin material yielded by curing an uncured liquid crystal polymer or the like.

An “electrically conductive material” in the present disclosure may include a composition of any of a metal material, an alloy of metal materials, a cured metal paste, and a conductive polymer. Examples of the metal material include copper, silver, palladium, gold, platinum, aluminum, chrome, nickel, cadmium lead, selenium, manganese, tin, vanadium, lithium, cobalt, and titanium. The alloy includes a plurality of metal materials. The metal paste includes the result of kneading a powder of a metal material with an organic solvent and a binder. Examples of the binder include an epoxy resin, a polyester resin, a polyimide resin, a polyamide-imide resin, and a polyetherimide resin. Examples of the conductive polymer include a polythiophene polymer, a polyacetylene polymer, a polyaniline polymer, and a polypyrrole polymer.

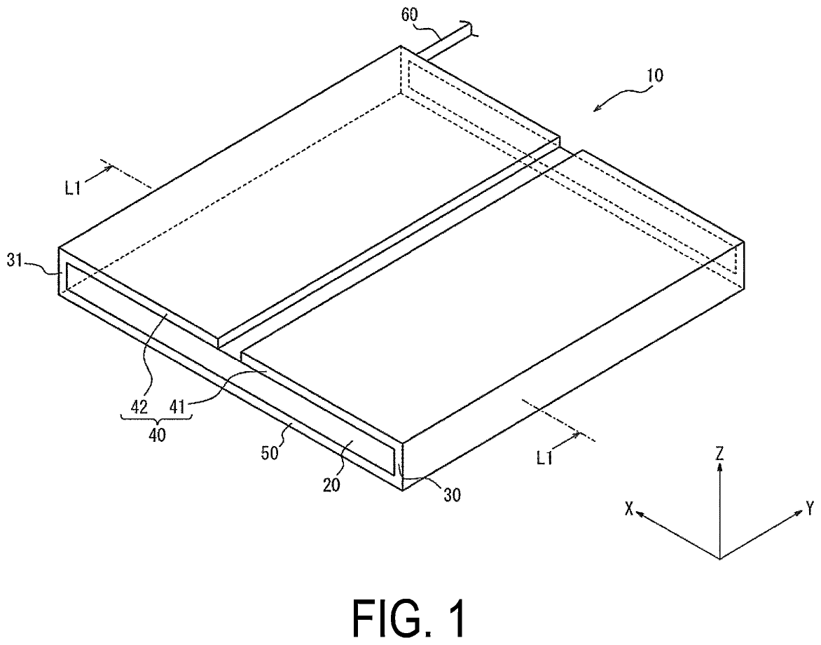

Hereinafter, a plurality of embodiments of the present disclosure will be described with reference to the drawings. Of the components illustrated in FIGS. 1 to 16, the same components are denoted by the same reference signs.

In the present disclosure, a “first direction” is a direction, as illustrated in FIG. 1, facing a first conductor 30 and a second conductor 31 and is a direction along a third conductor 40 and a fourth conductor 50. In the present disclosure, a “second direction” is a direction, as illustrated in FIG. 1, from the fourth conductor 50 toward the third conductor 40. In the present disclosure, a “first plane” is a plane including the first direction and the second direction. In the present disclosure, a “third direction” is a direction intersecting the first plane.

FIGS. 1 to 6 employ an XYZ coordinate system. Hereinafter, in a case where an X axis positive direction and an X axis negative direction are not particularly distinguished from each other, the X axis positive direction and the X axis negative direction are collectively referred to as an “X direction”. In a case where a Y axis positive direction and a Y axis negative direction are not particularly distinguished from each other, the Y axis positive direction and the Y axis negative direction are collectively referred to as a “Y direction”. In a case where a Z axis positive direction and a Z axis negative direction are not particularly distinguished from each other, the Z axis positive direction and the Z axis negative direction are collectively referred to as a “Z direction”.

In FIGS. 1 to 6, the first direction represents the X direction. The second direction represents the Z direction. The third direction represents the Y direction. The first plane represents an XY plane. However, the first direction may or may not be orthogonal to the second direction. It is only required that the first direction intersect the second direction. The third direction may or may not be orthogonal to the XY plane as the first plane. It is only required that the third direction intersect the first plane.

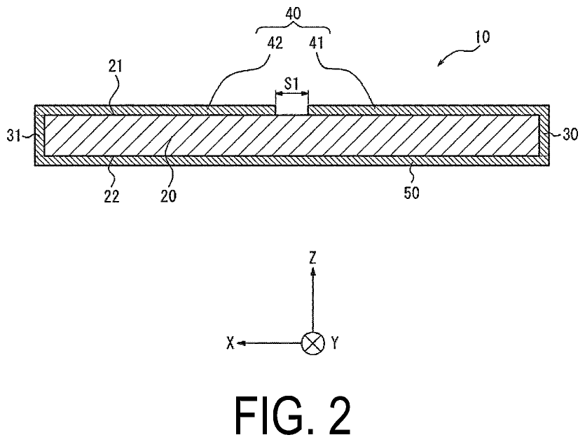

FIG. 1 is a perspective view of an antenna 10 according to an embodiment of the present disclosure. FIG. 2 is a cross-sectional view of the antenna 10 taken along the line L1-L1 illustrated in FIG. 1.

As illustrated in FIG. 1, the antenna 10 includes a base 20, the first conductor 30, the second conductor 31, the third conductor 40, the fourth conductor 50, and a feed line 60. The first conductor 30 and the second conductor 31 are also referred to as a conductor pair. The first conductor 30, the second conductor 31, the third conductor 40, the fourth conductor 50, and the feed line 60 each include an electrically conductive material. The first conductor 30, the second conductor 31, the third conductor 40, the fourth conductor 50, and the feed line 60 may include an identical electrically conductive material or different electrically conductive materials.

The antenna 10 exhibits an artificial magnetic conductor character with respect to electromagnetic waves of a predetermined frequency that are incident on a surface including the third conductor 40 from the outside.

In the present disclosure, the “artificial magnetic conductor character” means a characteristic of a surface having a zero degree phase difference between incident waves and reflected waves at a resonant frequency. The antenna 10 may have, as an operating frequency, at least one neighborhood of at least one resonant frequency. On a surface having the artificial magnetic conductor character, the phase difference between the incident waves and the reflected waves in an operating frequency band ranges from more than ˜90 degrees to less than +90 degrees.

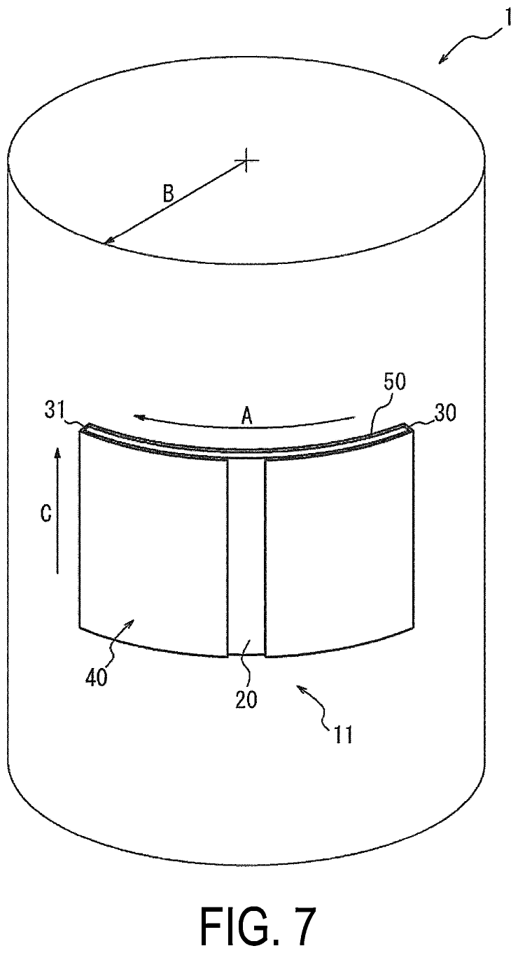

The antenna 10 has bending deformable flexibility in a cross-sectional view along an XZ plane as illustrated in FIG. 2. In other words, the antenna 10 has bending deformable flexibility in a cross-sectional view along the XZ plane. The antenna 10 having bending deformable flexibility in a cross-sectional view along the XZ plane, the antenna 10 can be disposed in, for example, a structure 1 as illustrated in FIG. 7 described below.

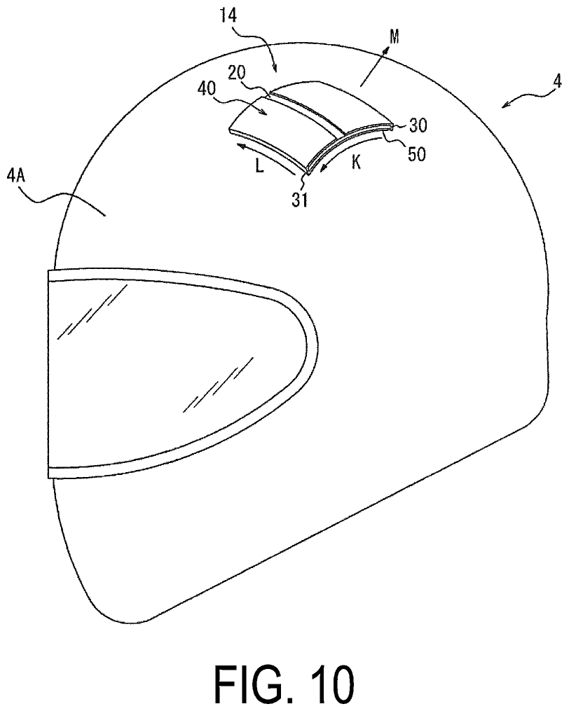

The antenna 10 may be bending deformable in a cross-sectional view along a YZ plane. In other words, the antenna 10 may have bending deformable flexibility in a cross-sectional view along a YX plane. The antenna 10 having bending deformable flexibility in a cross-sectional view along the YX plane can be disposed in, for example, a structure 4 as illustrated in FIG. 10 described below.

The antenna 10 may be convexly curvable toward a direction from the fourth conductor 50 toward the third conductor 40. In other words, the antenna 10 may have convexly curvable flexibility toward the direction from the fourth conductor 50 toward the third conductor 40.

The antenna 10 may be configured as a flexible printed circuit (FPC). The antenna 10 configured as the flexible printed circuit may have flexibility. The antenna 10 may have a flat shape extending along the XY plane. The thickness of the antenna 10 in the Z direction may be adjusted as appropriate in accordance with the degree of bending deformation or the like of the antenna 10.

The base 20 includes a dielectric material. The base 20 may have any shape in accordance with the shape of, for example, the third conductor 40. The base 20 may have a substantially rectangular shape. The base 20 has bending deformable flexibility. The relative permittivity of the base 20 may be adjusted as appropriate in accordance with the desired operating frequency of the antenna 10. As illustrated in FIG. 2, the base 20 includes an upper surface 21 and a lower surface 22. The upper surface 21 is one of two surfaces substantially parallel to the XY plane that are included in the base 20, the one being located on a Z axis positive direction side. The lower surface 22 is one of two surfaces substantially parallel to the XY plane that are included in the base 20, the one being located on a Z axis negative direction side.

The first conductor 30 is located on an X axis negative direction side of the second conductor 31. The first conductor 30 may be located at an end portion of the base 20 on the X axis negative direction side. The first conductor 30 is along the Y direction. The first conductor 30 extends along the Z direction from the fourth conductor 50 toward the third conductor 40. The first conductor 30 may extend along the YZ plane. The first conductor 30 may have a thin plate shape. The first conductor 30 may have a substantially rectangular shape. The first conductor 30 having the substantially rectangular shape has its longitudinal direction along the Y direction. The first conductor 30 has bending deformable flexibility.

An end portion of the first conductor 30 on the Z axis negative direction side is electrically connected to an end portion of the fourth conductor 50 on the X axis negative direction side. An end portion of the first conductor 30 on the Z axis positive direction side is electrically connected to an end portion of a fifth conductor 41 on the X axis negative direction side, the fifth conductor 41 being of the third conductor 40 and to be described below.

The second conductor 31 faces the first conductor 30 in the X direction. The second conductor 31 is located on an X axis positive direction side of the first conductor 30. The second conductor 31 may be located at an end portion of the base 20 on the X axis positive direction side. The second conductor 31 extends along the Y direction. The second conductor 31 extends along the Z direction from the fourth conductor 50 toward the third conductor 40. The second conductor 31 may extend along the YZ plane. The second conductor 31 may have a thin plate shape. The second conductor 31 may have a substantially rectangular shape. The second conductor 31 having the substantially rectangular shape has its longitudinal direction along the Y direction. The second conductor 31 has bending deformable flexibility.

An end portion of the second conductor 31 on the Z axis negative direction side is electrically connected to an end portion of the fourth conductor 50 on the X axis positive direction side. An end portion of the second conductor 31 on the Z axis positive direction side is electrically connected to an end portion of a sixth conductor 42 on the X axis positive direction side, the sixth conductor 42 being of the third conductor 40 and to be described below.

The third conductor 40 is along the X direction. The third conductor 40 may extend along the XY plane. The third conductor 40 is located between the first conductor 30 and the second conductor 31. The third conductor 40 includes the fifth conductor 41 and the sixth conductor 42. The fifth conductor 41 and the sixth conductor 42 may include an identical electrically conductive material or different electrically conductive materials.

The fifth conductor 41 and the sixth conductor 42 are located on the upper surface 21 of the base 20. A portion of the fifth conductor 41 and a portion of the sixth conductor 42 may be located inside the base 20. The fifth conductor 41 and the sixth conductor 42 may each have a thin plate shape. The fifth conductor 41 and the sixth conductor 42 may each have a substantially rectangular shape. The fifth conductor 41 and the sixth conductor 42 have bending deformable flexibility.

The fifth conductor 41 is electrically connected to the first conductor 30. For example, the end portion of the fifth conductor 41 on the X axis negative direction side is electrically connected to the end portion of the first conductor 30 on the Z axis positive direction side. The end portion of the fifth conductor 41 on the X axis negative direction side may be integrated with the end portion of the first conductor 30 on the Z axis positive direction side.

The sixth conductor 42 is electrically connected to the second conductor 31. For example, the end portion of the sixth conductor 42 on the X axis positive direction side is electrically connected to the end portion of the second conductor 31 on the Z axis positive direction side. The end portion of the sixth conductor 42 on the X axis positive direction side may be integrated with the end portion of the second conductor 31 on the Z axis positive direction side.

The fifth conductor 41 and the sixth conductor 42 are capacitively connected to each other. For example, an end portion of the fifth conductor 41 on the X axis positive direction side and an end portion of the sixth conductor 42 on the X axis negative direction side face each other. The end portion of the fifth conductor 41 on the X axis positive direction side and the end portion of the sixth conductor 42 on the X axis negative direction side have a gap S1 therebetween. The fifth conductor 41 and the sixth conductor 42 may be capacitively connected with the gap S1 located between the end portion of the fifth conductor 41 on the X axis positive direction side and the end portion of the sixth conductor 42 on the X axis negative direction side. The width of the gap S1 in the X direction may be adjusted as appropriate in accordance with the desired operating frequency of the antenna 10.

The third conductor 40 capacitively connects the first conductor 30 and the second conductor 31. For example, the fifth conductor 41, as described above, is electrically connected to the first conductor 30. The sixth conductor 42 is electrically connected to the second conductor 31. The fifth conductor 41 and the sixth conductor 42 may be capacitively connected by the gap S1.

The fourth conductor 50 is along the X direction. The fourth conductor 50 may extend along the XY plane. The fourth conductor 50 is separated from the third conductor 40 in the Z direction. The fourth conductor 50 may face the third conductor 40 in the Z direction. The fourth conductor 50 may be located on the lower surface 22 of the base 20. A portion of the fourth conductor 50 may be located inside the base 20. The fourth conductor 50 may have any shape in accordance with the shape of the third conductor 40. The fourth conductor 50 may have a thin plate shape. The fourth conductor 50 may have a substantially rectangular shape. The fourth conductor 50 has bending deformable flexibility.

The fourth conductor 50 is electrically connected to the first conductor 30 and the second conductor 31. For example, the end portion of the fourth conductor 50 on the X axis negative direction side is electrically connected to the end portion of the first conductor 30 on the Z axis negative direction side. The end portion of the fourth conductor 50 on the X axis positive direction side is electrically connected to the end portion of the second conductor 31 on the Z axis negative direction side.

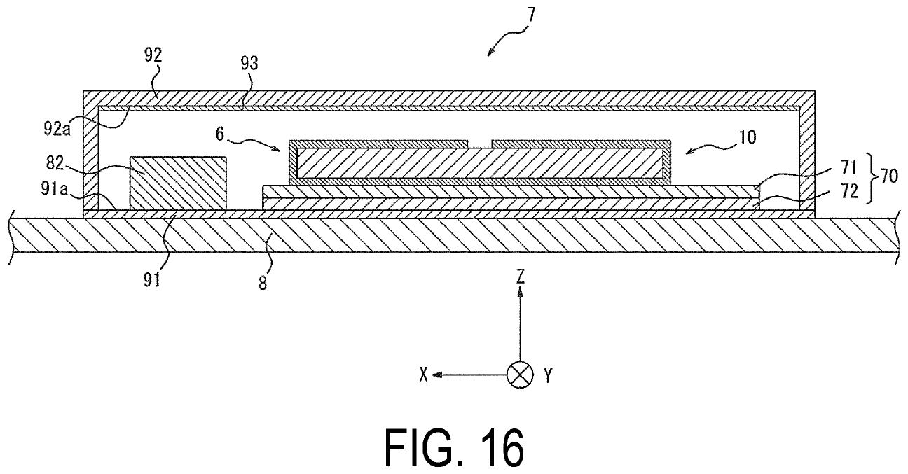

The fourth conductor 50 provides a reference potential in the antenna 10. The fourth conductor 50 may be electrically connected to the ground of the device including the antenna 10. For example, as illustrated in FIG. 16 described below, a portion of the fourth conductor 50 may be electrically connected to a ground conductor 71 of a circuit substrate 70. A variety of parts of the device including the antenna 10 may be located on the Z axis negative direction side of the fourth conductor 50. As illustrated in, for example, FIG. 7 described below, the antenna 10 disposed in the structure may be located on the Z axis negative direction side of the fourth conductor 50. The antenna 10, even with a variety of parts and structures located on the Z axis negative direction side of the fourth conductor 50, can maintain the radiation efficiency at an operating frequency by having the artificial magnetic conductor character described above.

The feed line 60 is electrically connected to the third conductor 40. In the present disclosure, an “electromagnetic connection” may be an electrical connection or a magnetic connection. In the present embodiment, one end of the feed line 60 is electrically connected to the sixth conductor 42 of the third conductor 40. The other end of the feed line 60 is electrically connected to an external device or the like.

The feed line 60 is configured to supply electrical power from the external device or the like to the third conductor 40 when the antenna 10 emits electromagnetic waves. The feed line 60 is configured to supply electrical power from the third conductor 40 to the external device or the like when the antenna 10 receives electromagnetic waves.

When the antenna 10 resonates at a predetermined frequency, a loop electrical current may occur that flows in a loop shape through the first conductor 30, the second conductor 31, the third conductor 40, and the fourth conductor 50. The first conductor 30 can be viewed from the loop electrical current as an electric wall extending on the YZ plane on the X axis negative direction side, and the second conductor 31 can be viewed from the same as an electric wall extending on the YZ plane on the X axis positive direction side. That is, the first conductor 30 and the second conductor 31 can function as a pair of electric walls. Further, viewed from the loop electrical current, a conductor or the like is located neither on the Y axis positive direction side nor on the Y axis negative direction side. That is, viewed from the loop electrical current, the Y axis positive direction side and the Y axis negative direction side are electrically open. With the Y axis positive direction side and the Y axis negative direction side electrically open, the XZ plane on the Y axis positive direction side and the XY plane on the Y axis negative direction side can be viewed from the loop electrical current as magnetic walls. That is, in the antenna 10, a conductor or the like is located neither on the Y axis positive direction side nor on the Y axis negative direction side, and thus the XY plane on the Y axis positive direction side and the XY plane on the Y axis negative direction side can function as a pair of magnetic walls. With the loop electrical current surrounded by the pair of electric walls and the pair of magnetic walls, the antenna 10 exhibits the artificial magnetic conductor character with respect to electromagnetic waves at a predetermined frequency that are incident on the upper surface 21 of the base 20 from the Z axis positive direction side.

Thus, the antenna 10, even without a large number of resonator structures arrayed therein, exhibits the artificial magnetic conductor character with respect to electromagnetic waves at a predetermined frequency that are incident on the upper surface 21 of the base 20 from the Z axis positive direction side. Also, the antenna 10 is bent in at least the X direction. The antenna 10 bent in at least the X direction may be disposed on a curved surface. Thus, the present embodiment can provide a novel antenna 10.

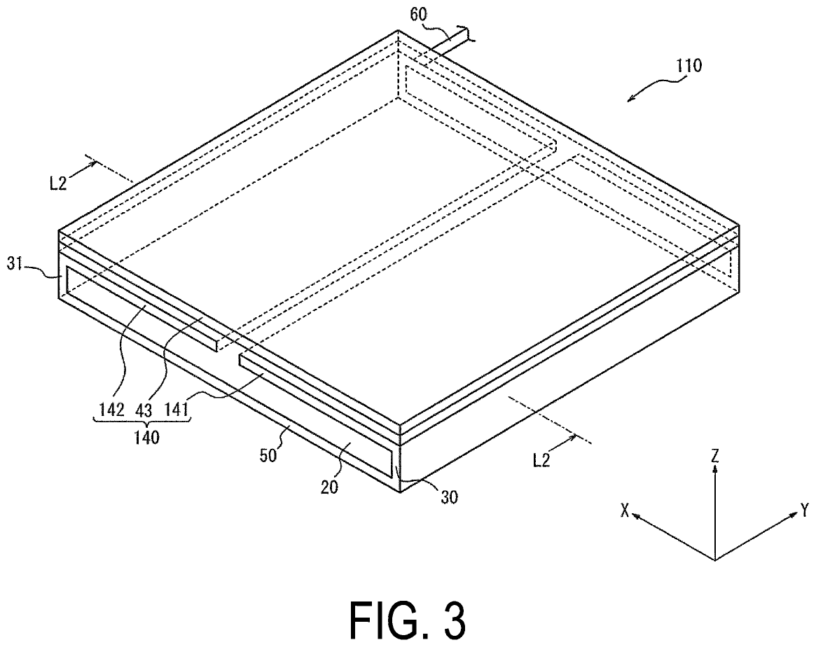

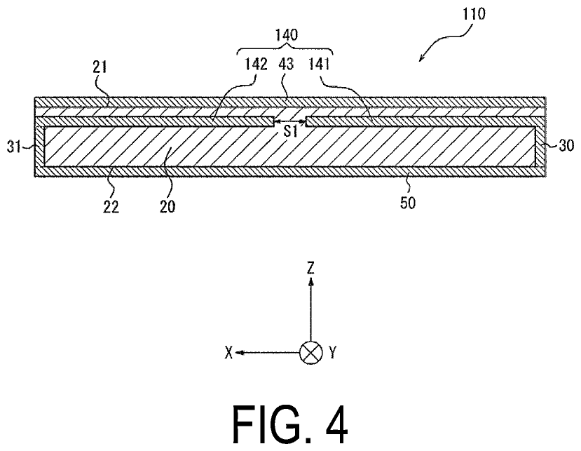

FIG. 3 is a perspective view of an antenna 110 according to an embodiment of the present disclosure. FIG. 4 is a cross-sectional view of the antenna 110 taken along the line L2-L2 illustrated in FIG. 3.

As illustrated in FIG. 3, the antenna 110 includes the base 20, the first conductor 30, the second conductor 31, a third conductor 140, the fourth conductor 50, and the feed line 60. The third conductor 140 includes a fifth conductor 141, a sixth conductor 142, and a seventh conductor 43. The fifth conductor 141, the sixth conductor 142, and the seventh conductor 43 each include an electrically conductive material. The fifth conductor 141, the sixth conductor 142, the seventh conductor 43, the first conductor 30, the second conductor 31, the fourth conductor 50, and the feed line 60 may include an identical electrically conductive material or different electrically conductive materials.

The antenna 110 may exhibit the artificial magnetic conductor character with respect to electromagnetic waves at a predetermined frequency that are incident on a surface including the third conductor 140 from the outside.

The antenna 110 is bending deformable in a cross-sectional view along the XZ plane as illustrated in FIG. 4. In other words, the antenna 110 has bending deformable flexibility in a cross-sectional view along the XZ plane. The antenna 110 bending deformable in a cross-sectional view along the XZ plane can be disposed in, for example, the structure 1 as illustrated in FIG. 7 described below.

The antenna 110 may be bending deformable in a cross-sectional view along the YZ plane. In other words, the antenna 110 may have bending deformable flexibility in a cross-sectional view along the YZ plane. The antenna 110 bending deformable in a cross-sectional view along the YZ plane can be disposed in, for example, the structure 4 as illustrated in FIG. 10 described below.

The antenna 110 may be convexly curvable toward a direction from the fourth conductor 50 toward the third conductor 140. In other words, the antenna 110 may have convexly curvable flexibility toward the direction from the fourth conductor 50 toward the third conductor 140.

The antenna 110 may be configured as a flexible printed circuit. The antenna 110 configured as a flexible printed circuit may have flexibility. The antenna 110 may have a flat shape extending along the XY plane. The thickness of the antenna 110 in the Z direction may be adjusted as appropriate in accordance with the degree of bending deformation or the like of the antenna 110.

As illustrated in FIG. 4, the fifth conductor 141 is located inside the base 20. Other configurations of the fifth conductor 141 are identical or similar to those of the fifth conductor 41 as illustrated in FIG. 1. The sixth conductor 142 is located inside the base 20. Other configurations of the sixth conductor 142 are identical or similar to those of the sixth conductor 42 as illustrated in FIG. 1.

The seventh conductor 43 is located on the upper surface 21 of the base 20. The seventh conductor 43 is separated from the fifth conductor 141 and the sixth conductor 142 in the Z direction. The seventh conductor 43 is located on the Z axis positive direction side of the fifth conductor 141 and the sixth conductor 142. The seventh conductor 43 is not electrically connected to the fifth conductor 141 and the sixth conductor 142. The seventh conductor 43 may extend along the XY plane. The seventh conductor 43 may have a thin plate shape. The seventh conductor 43 may have a substantially rectangular shape. The seventh conductor 43 has bending deformable flexibility.

The seventh conductor 43 capacitively connects the fifth conductor 141 and the sixth conductor 142. For example, as described above, the seventh conductor 43 is separated from the fifth conductor 141 and the sixth conductor 142 in the Z direction. On the XY plane, a portion of the seventh conductor 43 may overlap at least a portion of the fifth conductor 141. On the XY plane, another portion of the seventh conductor 43 may overlap at least a portion of the sixth conductor 142. The seventh conductor 43 may be capacitively connected to the fifth conductor 141 and the sixth conductor 142 by overlapping a portion of the fifth conductor 141 and a portion of the sixth conductor 142.

Other configurations and effects of the antenna 110 are identical or similar to those of the antenna 10 as illustrated in FIG. 1.

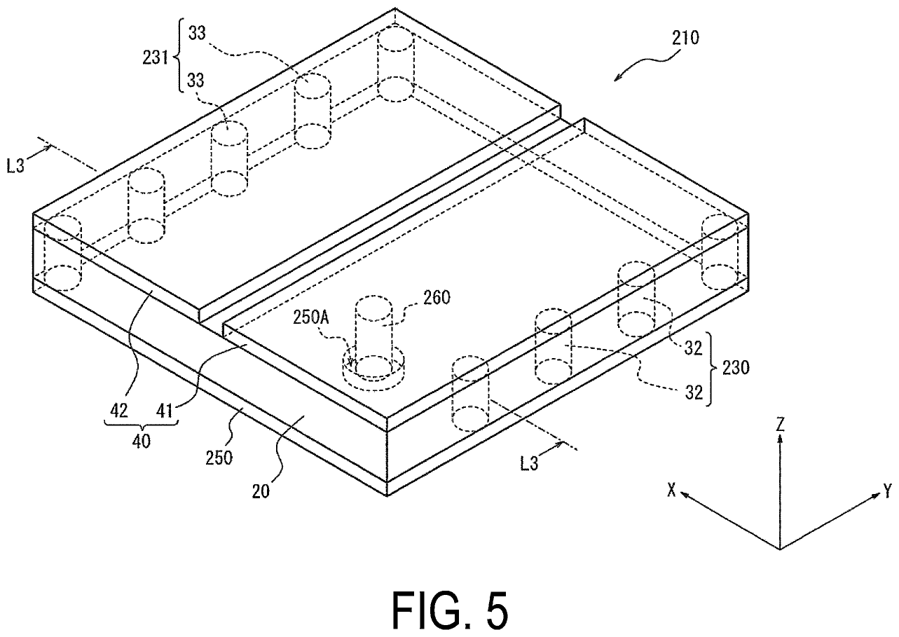

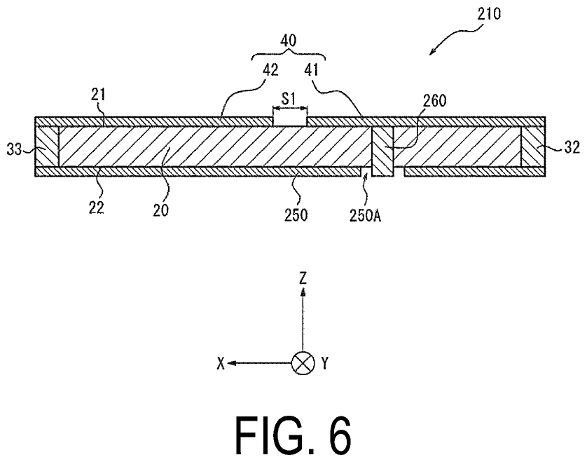

FIG. 5 is a perspective view of an antenna 210 according to an embodiment of the present disclosure. FIG. 6 is a cross-sectional view of the antenna 210 taken along the line L3-L3 illustrated in FIG. 5.

As illustrated in FIG. 5, the antenna 210 includes the base 20, a first conductor 230 including at least one first connection conductor 32, a second conductor 231 including at least one second connection conductor 33, the third conductor 40, a fourth conductor 250, and a feed line 260. The first connection conductor 32, the second connection conductor 33, the fourth conductor 250, and the feed line 260 includes an electrically conductive material. The first connection conductor 32, the second connection conductor 33, the third conductor 40, the fourth conductor, 250, and the feed line 260 may include an identical electrically conductive material or different electrically conductive materials.

The antenna 210 may exhibit the artificial magnetic conductor character with respect to electromagnetic waves at a predetermined frequency that are incident on a surface including the third conductor 40 from the outside.

The antenna 210 is bending deformable in a cross-sectional view along the XZ plane as illustrated in FIG. 6. In other words, the antenna 210 has bending deformable flexibility in a cross-sectional view along the XZ plane. The antenna 210 having bending deformable flexibility in a cross-sectional view along the XZ plane can be disposed in, for example, the structure 1 as illustrated in FIG. 7 described below.

The antenna 210 may be bending deformable in a cross-sectional view along the YZ plane. In other words, the antenna 210 may have bending deformable flexibility in a cross-sectional view along the YZ plane. The antenna 210 bending deformable in a cross-sectional view along the YZ plane can be disposed in, for example, the structure 4 as illustrated in FIG. 10 described below.

The antenna 210 may be convexly curvable toward a direction from the fourth conductor 250 toward the third conductor 40. In other words, the antenna 210 may have convexly curvable flexibility toward the direction from the fourth conductor 250 toward the third conductor 40.

The antenna 210 may be configured as a flexible printed circuit. The antenna 210 may have flexibility by being configured as a flexible printed circuit. The antenna 210 may have a flat shape extending along the XY plane. The thickness of the antenna 210 in the Z direction may be adjusted as appropriate in accordance with the degree of bending deformation or the like of the antenna 210.

As illustrated in FIG. 5, in a configuration in which the first conductor 230 includes a plurality of the first connection conductors 32, the plurality of first connection conductors 32 may be aligned apart from each other in the Y direction. The plurality of first connection conductors 32 may be aligned in the Y direction at substantially equal intervals.

As illustrated in FIG. 6, the first connection conductor 32 extends along the Z direction from the fourth conductor 250 to the fifth conductor 41. The first connection conductor 32 includes two end portions. The first connection conductor 32 may be configured such that an end portion of the first connection conductor 32 is electrically connected to the fourth conductor 250 and the other end portion thereof is electrically connected to the fifth conductor 41. Examples of the first connection conductor 32 may include a through hole conductor and a via conductor.

Other configurations and effects of the first conductor 230 are identical or similar to those of the first conductor 30 as illustrated in FIG. 1.

As illustrated in FIG. 5, in a configuration in which the second conductor 231 includes a plurality of the second connection conductors 33, the plurality of second connection conductors 33 may be aligned apart from each other in the Y direction. The plurality of second connection conductors 33 may be aligned in the Y direction at substantially equal intervals.

As illustrated in FIG. 6, the second connection conductor 33 extends along the Z direction from the fourth conductor 250 to the sixth conductor 42. The second connection conductor 33 includes two end portions. The second connection conductor 33 may be configured such that an end portion of the second connection conductor 33 is electrically connected to the fourth conductor 250 and the other end portion thereof is electrically connected to the sixth conductor 42. Examples of the second connection conductor 33 may include a through hole conductor and a via conductor.

Other configurations and effects of the second conductor 231 are identical or similar to those of the second conductor 31 as illustrated in FIG. 1.

The fourth conductor 250 includes an opening 250A. The opening 250A may have any shape in accordance with the structure of the feed line 260. Other configurations and effects of the fourth conductor 250 are identical or similar to those of the fourth conductor 50 as illustrated in FIG. 1.

The feed line 260 is located inside the base 20. The feed line 260 extends along the Z direction. The feed line 260 includes two end portions. The feed line 260 has one end portion electrically connected to the fifth conductor 41. As illustrated in FIG. 6, the feed line 260 may have the other end portion extending outwardly from the opening 250A. The other end portion of the feed line 260 may be electrically connected to an external device or the like. The feed line 260 may include a through hole conductor and a via conductor. Other configurations and effects of the feed line 260 are identical or similar to those of the feed line 60 as illustrated in FIG. 1.

Other configurations and effects of antenna 210 are identical or similar to those of the antenna 10 as illustrated in FIG. 1.

FIG. 7 is a diagram illustrating an arrangement of an antenna 11 according to an embodiment of the present disclosure. The antenna 11 has the same structure as that of the antenna 10. However, the antenna 11 may have the same structure as the antenna 110 instead of that of the antenna 10, and may have the same structure as that of the antenna 210. The antenna 11 is located in the structure 1.

The structure 1 has a cylindrical shape. The structure 1 may be a portion of a supporter or a pipeline such as a utility pole or a road sign. Examples of the utility pole may include an electrical power pole, a telephone pole, a joint pole, and an overhead line pole. The structure 1 may be installed outdoors. The structure 1 may be managed by a predetermined operator or the like. The structure 1 is not limited to an artifact. The structure 1 may be a natural object, provided that the natural object has a cylindrical shape. The structure 1 may include a material containing metal.

A direction A is a circumferential direction of the structure 1. The direction A is along a curve. A direction B is a radial direction of the structure 1. A direction C is a direction in which the structure 1 extends. The structure 1 extends along a straight line. The direction C is along a straight line.

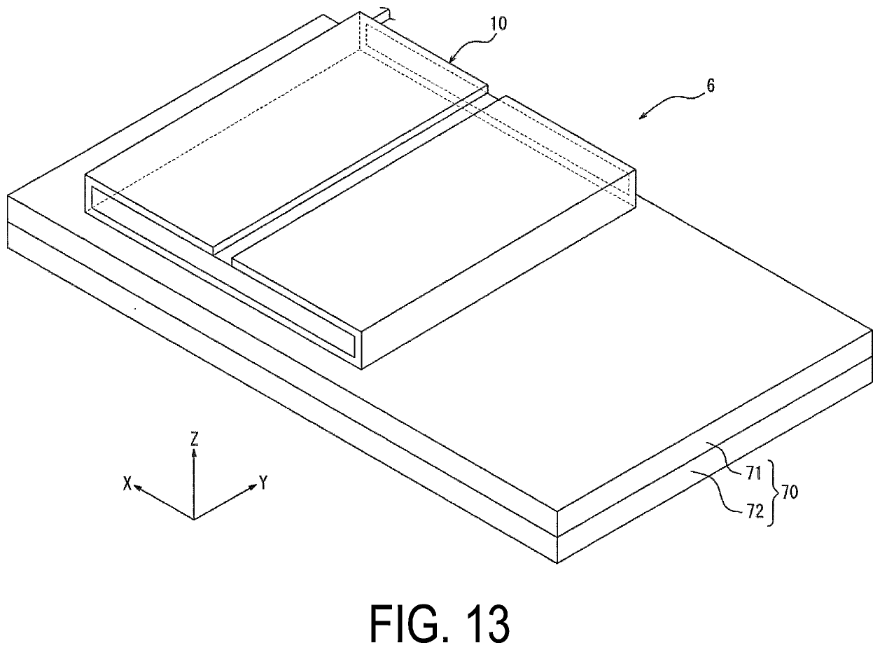

The antenna 11 may be disposed on a surface of the structure 1. The antenna 11 may be disposed on the surface of the structure 1 via the circuit substrate 70 as illustrated in FIG. 13 described below. The antenna 11 may be disposed on the surface of the structure 1 via the circuit substrate 70 and a first housing 91 as are illustrated in FIG. 16 described below. In a case where the structure 1 is formed of a material other than metal, the antenna 11 may be embedded in the structure 1.

In the antenna 11, the first direction along the third conductor 40 and the fourth conductor 50 is along a curve. For example, in the antenna 11, the first direction along the third conductor 40 and the fourth conductor 50 is along the direction A, which is along a curve. In the antenna 11, the base 20, the third conductor 40, and the fourth conductor 50 are curved along the direction A, which is along a curve.

The antenna 11 is convexly curved toward a direction from the fourth conductor 50 toward the third conductor 40. For example, in the antenna 11, the direction from the fourth conductor 50 to the third conductor 40 is along the direction B. The antenna 11 is convexly curved toward the direction B. In the antenna 11, the base 20, the third conductor 40, and the fourth conductor 50 are convexly curved toward the direction B.

In the antenna 11, the third direction along the first conductor 30 and the second conductor 31 is along a straight line. For example, in the antenna 11, the third direction along the first conductor 30 and the second conductor 31 is along the direction C, which is along a straight line.

In the antenna 11, as described above, the first conductor 30 and the second conductor 31 can function as a pair of electric walls. As described above, the first conductor 30 and the second conductor 31 face one another in the first direction. Further, the first conductor 30 and the second conductor 31 are along the third direction. In the antenna 11, the first direction is along the direction A and the third direction is along the direction C, and thus the third direction along the first conductor 30 and the second conductor 31 is along a straight line. With the third direction along the first conductor 30 and the second conductor 31 being along a straight line, the degree of deformation of each of the first conductor 30 and the second conductor 31 can be reduced. By reducing the degree of deformation of each of the first conductor 30 and the second conductor 31, the function each of the first conductor 30 and the second conductor 31 as an electric wall can be maintained. Such a configuration can enhance the robustness of the antenna 11.

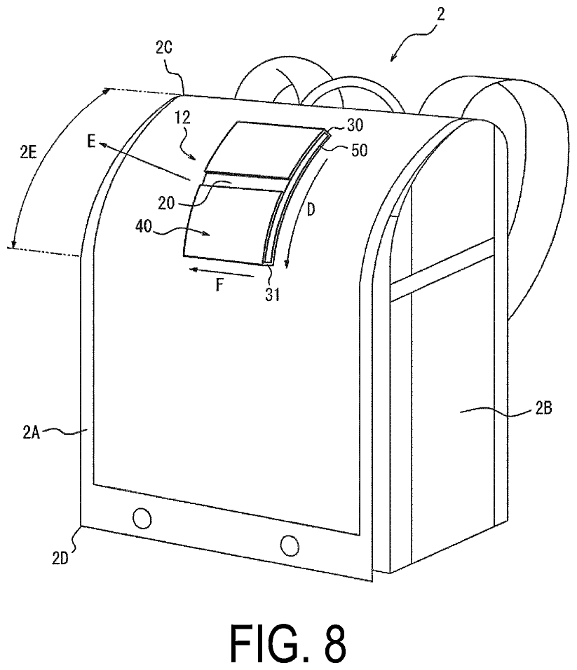

FIG. 8 is a diagram illustrating an arrangement of an antenna 12 according to another embodiment of the present disclosure. The antenna 12 has the same structure as that of the antenna 10. However, the antenna 12 may have the same structure as that of the antenna 110 instead of that of the antenna 10, and may have the same structure as that of the antenna 210. The antenna 12 is located in a structure 2.

The structure 2 is a school bag. The structure 2 may be used by a child. The structure 2 may include any material. The structure 2 includes a cover 2A and a body portion 2B. However, the structure including the antenna 12 is not limited to the structure 2. The antenna 12 may be located in any bag including a cover.

The cover 2A includes an end portion 2C and an end portion 2D. The end portion 2C and the end portion 2D face each other. The end portion 2C is fixed to the body portion 2B. The end portion 2D is released from the body portion 2B. The cover 2A opens and closes to the body portion 2B. When the cover 2A is open to the body portion 2B, the end portion 2D is separated from the body portion 2B. When the cover 2A is closed to the body portion 2B, the end portion 2D is located near the body portion 2B. The cover 2A includes a region 2E. The region 2E is a portion of a surface facing the outside of the cover 2A, the portion being on an end portion 2C side.

A direction D is a direction from the end portion 2C toward the end portion 2D along the surface of the cover 2A. The region 2E is along a curve in the direction D. The radius of curvature of the region 2E in the direction D is smaller with the cover 2A being closed to the body portion 2B than with the cover 2A being open to the body portion 2B.

A direction E is a direction from the surface of the cover 2A toward the outside, the direction being also a direction perpendicular to the surface of the cover 2A. The region 2E may be convexly curved toward the direction E when the cover 2A is closed to the body portion 2B.

A direction F is a direction substantially orthogonal to the direction D. The direction F is along a straight line. The direction F in the region 2E is along a straight line, regardless of whether the cover 2A is closed or open to the body portion 2B.

The antenna 12 is located in the region 2E. The region 2E may face the sky while the child is carrying the structure 2 on his/her back. The antenna 12 located in the region 2E can efficiently emit electromagnetic waves while the child is carrying the structure 2 on his/her back.

The antenna 12 may be disposed on a surface of the region 2E. The antenna 12 may be disposed on the surface of the region 2E via the circuit substrate 70 as illustrated in FIG. 13 described below. The antenna 12 may be disposed on the surface of the region 2E via the circuit substrate 70 and the first housing 91 as are illustrated in FIG. 16 described below. In a case where the cover 2A is formed of a material other than metal, the antenna 12 may be embedded in the cover 2A or may be disposed on a back side surface of the cover 2A.

In the antenna 12, the first direction along the third conductor 40 and the fourth conductor 50 is bent along a curve. For example, the antenna 12 is located in the region 2E. In the antenna 12, the first direction along the third conductor 40 and the fourth conductor 50 is along the direction D, which is along a curve in the region 2E. In the antenna 12, the base 20, the third conductor 40, and the fourth conductor 50 are bent along the direction D, which is along a curve.

The antenna 12 is convexly curved toward the direction from the fourth conductor 50 toward the third conductor 40. For example, in the antenna 12, the direction from the fourth conductor 50 toward the third conductor 40 is along the direction E. The antenna 12 is convexly curved toward the direction E. In the antenna 12, the base 20, the third conductor 40, and the fourth conductor 50 are convexly curved toward the direction E.

In the antenna 12, the third direction along the first conductor 30 and the second conductor 31 is along a straight line. For example, in the antenna 12, the third direction along the first conductor 30 and the second conductor 31 is along the direction F, which is along a straight line.

The radius of curvature of the antenna 12 in the first direction may change depending on the open/closed state of the cover 2A with regard to the body portion 2B. For example, the radius of curvature of the antenna 12 in the first direction is smaller with the cover 2A closed to the body portion 2B than with the cover 2A open to the body portion 2B. Even with a change in the radius of curvature of the antenna 12 in the first direction, the degree of deformation of each of the first conductor 30 and the second conductor 31 is reduced due to the third direction, along the first conductor 30 and the second conductor 31, being along the direction F. By reducing the degree of deformation of each of the first conductor 30 and the second conductor 31, the function of each of the first conductor 30 and the second conductor 31 as an electric wall can be maintained. Such a configuration can enhance the emission efficiency of the antenna 12.

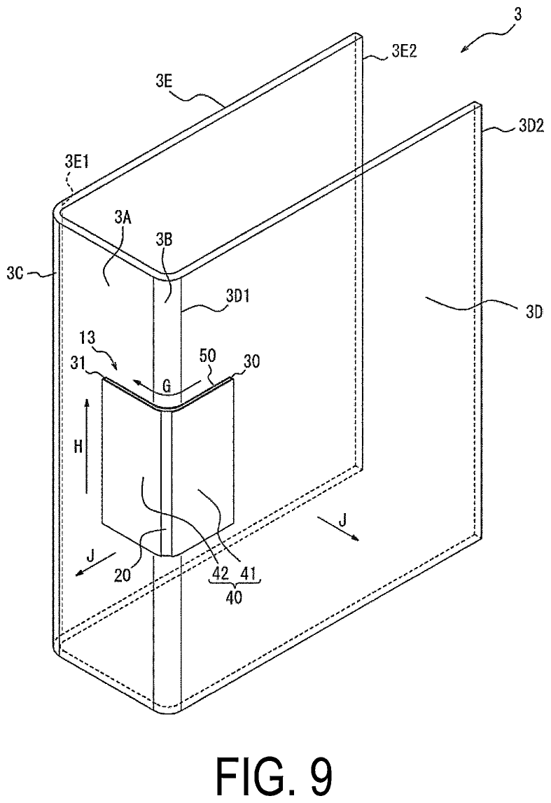

FIG. 9 is a diagram illustrating an arrangement of an antenna 13 according to yet another embodiment of the present disclosure. The antenna 13 has the same structure as that of the antenna 10. However, the antenna 13 may have the same structure as that of the antenna 110 instead of that of the antenna 10, and may have the same structure as that of the antenna 210. The antenna 13 is located in a structure 3.

The structure 3 has an opening/closing structure. The opening/closing structure is a structure that allows a predetermined element to switch between a closed state and an open state. The structure 3 is a binder for holding a document. The structure 3 may be used by an individual or managed in a facility such as a library. However, the structure including the antenna 13 is not limited to the structure 3. The antenna 13 may be located in any structure having an opening/closing structure. For example, the antenna 13 may be located in a door.

The structure 3 includes a spine 3A, a connection portion 3B, a connection portion 3C, a cover portion 3D, and a cover portion 3E. The cover portion 3D includes an end portion 3D1 and an end portion 3D2. The cover portion 3E includes an end portion 3E1 and an end portion 3E2. The spine 3A, the connection portion 3B, the connection portion 3C, the cover portion 3D, and the cover portion 3E may be integrated.

The spine 3A has an elongated shape. The spine 3A includes one end portion connected to the connection portion 3B. The spine 3A includes the other end portion connected to the connection portion 3C. The connection portion 3B connects the one end portion of the spine 3A and the end portion 3D1 of the cover portion 3D. The connection portion 3C connects the other end portion of the spine 3A and the end portion 3E1 of the cover portion 3E.

The end portion 3D1 of the cover portion 3D is fixed to the spine 3A via the connection portion 3B. The end portion 3D2 of the cover portion 3D is released from the spine 3A. The end portion 3E1 of the cover portion 3E is fixed to the spine 3A via the connection portion 3C. The end portion 3E2 of the cover portion 3E is released from the spine 3A. The closed state of each of the cover portion 3D and the cover portion 3E is a state in which each of the cover portion 3D and the cover portion 3E is substantially perpendicular to the spine 3A. The open state of each of the cover portion 3D and the cover portion 3E is a state in which each of the cover portion 3D and the cover portion 3E is substantially parallel to the spine 3A.

A direction G is a direction from the end portion 3D2 of the cover portion 3D toward the end portion 3E2 of the cover portion 3E along a surface of the structure 3. In the direction G, the connection portion 3B is along a curve when the cover portion 3D is in a closed state. In the direction G, the connection portion 3B is along a straight line when the cover portion 3D is in an open state. The radius of curvature of the connection portion 3B in the direction G may be different depending on the open/closed state of the cover portion 3D.

A direction H is a direction along a longitudinal direction of the spine 3A. In the direction H, the spine 3A and the connection portion 3B are along a straight line regardless of whether the cover portion 3D is in the closed state or the open state.

A direction J is a direction from the surface of the structure 3 toward the outside, the direction being also a direction perpendicular to the surface of the structure 3. The connection portion 3B may be convexly curved toward the direction J when the cover portion 3D is in the closed state.

The antenna 13 may be located in a region including the connection portion 3B, the region being one of regions included in the structure 3. In the antenna 13, the gap S1 between the fifth conductor 41 and the sixth conductor 42 may be located in the connection portion 3B.

The antenna 13 may be disposed on the surface of the structure 3. The antenna 13 may be disposed on the surface of the structure 3 via the circuit substrate 70 as illustrated in FIG. 13 described below. The antenna 13 may be disposed on the surface of the structure 3 via the circuit substrate 70 and the first housing 91 as are illustrated in FIG. 16 below. In a case where the structure 3 is formed of a material other than metal, the antenna 13 may be embedded in the structure 3 or on a back side of the structure 3.

In the antenna 13, the first direction along the third conductor 40 and the fourth conductor 50 may be bent along a curve. For example, in the antenna 13, the first direction along the third conductor 40 and the fourth conductor 50 is along the direction G. The first direction may be bent along a curve with the direction G being along a curve when the cover portion 3D is in the closed state. When the cover portion 3D is in the closed state, the antenna 13 may have the base 20, the third conductor 40, and the fourth conductor 50 being bent along the direction G, which is along a curve.

The antenna 13 may be convexly curved toward a direction from the fourth conductor 50 toward the third conductor 40. For example, in the antenna 13, the direction from the fourth conductor 50 toward the third conductor 40 is along the direction J. The antenna 13 may be convexly curved toward the direction from the fourth conductor 50 toward the third conductor 40 when the cover portion 3D is in the closed state. When the cover portion 3D is in the closed state, the antenna 13 may have the base 20, the third conductor 40, and the fifth conductor convexly curvable.

In the antenna 13, the third direction along the first conductor 30 and the second conductor 31 is along a straight line. For example, in the antenna 13, the third direction along the first conductor 30 and the second conductor 31 is along the direction H, which is along a straight line.

The radius of curvature of the antenna 13 in the first direction may change depending on the open/closed state of the cover portion 3D. For example, when the cover portion 3D is in the closed state, the radius of curvature of the antenna 13 in the first direction may be smallest. As the cover portion 3D changes from the closed state to the open state, the radius of curvature of the antenna 13 in the first direction may increase. Even with a change in the radius of curvature of the antenna 13 in the first direction, the degree of deformation of each of the first conductor 30 and the second conductor 31 is reduced due to the third direction, along the first conductor 30 and the second conductor 31, being along the direction H. Such a configuration can enhance the robustness of the antenna 13, as with the antenna 12.

FIG. 10 is a diagram illustrating an arrangement of an antenna 14 according to yet another embodiment of the present disclosure. The antenna 14 has the same structure as that of the antenna 10. However, the antenna 14 may have the same structure as that of the antenna 110 instead of that of the antenna 10, and may have the same structure as that of the antenna 210. The antenna 14 is located in a structure 4.

The structure 4 is a rider helmet. The rider helmet may be mounted on the head of a motorcycle driver. The structure 4 includes a curved surface region 4A. The structure 4 may be formed of any material including metal. However, the structure including the antenna 14 is not limited to the structure 4. The antenna 14 may be located in any helmet including a curved surface region. For example, the antenna 14 may be located on a hard hat, a sports helmet, a safety helmet, or the like.

Of directions included in the curved surface region 4A, a direction K and a direction L are different directions from each other. The direction K and the direction L are each along a curve. The direction K and the direction L are orthogonal to each other, without being limited thereto. Of directions perpendicular to the curved surface region 4A, a direction M is a direction from the curved surface region 4A toward the outside.

The antenna 14 is located in the curved surface region 4A. The antenna 14 may be disposed on a surface of the curved surface region 4A. The antenna 14 may be disposed on the surface of the curved surface region 4A via the circuit substrate 70 as illustrated in FIG. 13 described below. The antenna 14 may be disposed on the surface of the curved surface region 4A via the circuit substrate 70 and the first housing 91 as are illustrated in FIG. 16 described below. In a case where the structure 4 is formed of a material other than metal, the antenna 14 may be embedded in the structure 4 or disposed on an inner surface of the structure 4.

In the antenna 14, the first direction along the third conductor 40 and the fourth conductor 50 is bent along a curve. For example, in the antenna 14, the first direction along the third conductor 40 and the fourth conductor 50 is along the direction K, which is along a curve. In the antenna 14, the third conductor 40 and the fourth conductor 50 are bent along the direction K, which is along a curve.

In the antenna 14, the third direction along the first conductor 30 and the second conductor 31 is bent along a curve. For example, in the antenna 14, the third direction along the first conductor 30 and the second conductor 31 is along the direction L, which is along a curve. In the antenna 14, the first conductor 30 and the second conductor 31 are bent along the direction L, which is along a curve.

The antenna 14 is convexly curved toward a direction from the fourth conductor 50 toward the third conductor 40. For example, in the antenna 14, the direction from the fourth conductor 50 toward the third conductor 40 is along the direction M. The antenna 14 is convexly curved toward the direction M. In the antenna 14, the base 20, the third conductor 40, and the fourth conductor 50 are convexly curved toward the direction M.

The radius of curvature of the antenna 14 in the third direction may be greater than the radius of curvature of the antenna 14 in the first direction. For example, the curved surface region 4A of the structure 4 may be formed to conform to the shape of the human head. The human head is not a complete sphere. Since the human head is not a complete sphere, the radius of curvature of the curved surface region 4A in the direction K and the radius of curvature thereof in the direction L may be different depending on the location of the curved surface region 4A. The antenna 14 may be disposed in a region, within the curved surface region 4A, where the radius of curvature in the direction L is greater than the radius of curvature in the direction K. In the region, the first direction of the antenna 14 may be along the direction K and the third direction of the antenna 14 may be along the direction L. In such a configuration, the radius of curvature of the antenna 14 in the third direction may be greater than the radius of curvature of the antenna 14 in the first direction.

In a configuration in which the radius of curvature of the antenna 14 in the third direction is greater than the radius of curvature thereof in the first direction, the degree of deformation of each of the first conductor 30 and the second conductor 31 is lower than in a configuration in which the radius of curvature of the antenna 14 in the third direction is the same as the radius of curvature thereof in the first direction. Such a configuration can enhance the robustness of the antenna 14, as with the antenna 12.

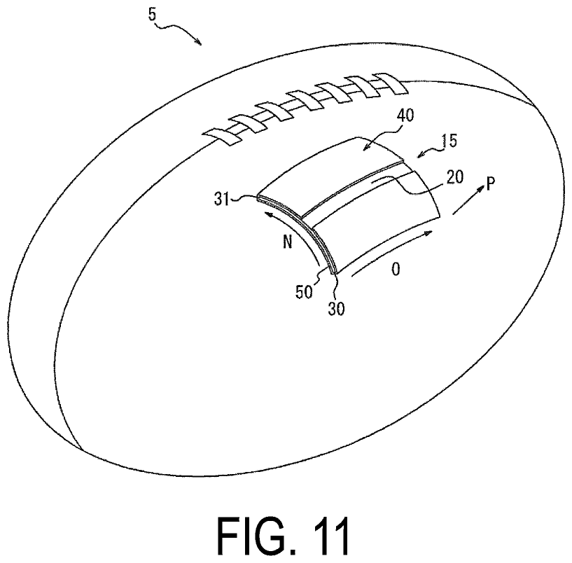

FIG. 11 is a diagram illustrating an arrangement of an antenna 15 according to yet another embodiment of the present disclosure. The antenna 15 has the same structure as that of the antenna 10. However, the antenna 15 may have the same structure as that of the antenna 110 instead of that of the antenna 10, and may have the same structure as that of the antenna 210. The antenna 15 is located in a structure 5.

The structure 5 is a ball having a substantially spheroidal shape. The surface of the structure 5 is a curved surface. The structure 5 may be a ball for rugby football, a ball for American football, or the like. The structure 5 may be formed of any material.

Of directions included in the surface of the structure 5, a direction N and a direction O are different directions from each other. The direction N and the direction O are each along a curve. The direction N and the direction O are orthogonal to each other, without being limited thereto. Of directions perpendicular to the surface of structure 5, a direction P is a direction from the surface of structure 5 toward the outside.

The antenna 15 may be disposed on the surface of the structure 5. The antenna 15 may be disposed on the surface of the structure 5 via the circuit substrate 70 as illustrated in FIG. 13 described below. The antenna 15 may be disposed on the surface of the structure 5 via the circuit substrate 70 and the first housing 91 as are illustrated in FIG. 16 described below. In a case where the structure 5 is formed of a material other than metal, the antenna 15 may be embedded in the structure 5.

In the antenna 15, the first direction along the third conductor 40 and the fourth conductor 50 is bent along a curve. For example, in the antenna 15, the first direction along the third conductor 40 and the fourth conductor 50 is along the direction N, which is along a curve. In the antenna 15, the base 20, the third conductor 40, and the fourth conductor 50 are bent along the direction N, which is along a curve.

In the antenna 15, the third direction along the first conductor 30 and the second conductor 31 is bent along a curve. For example, in the antenna 15, the third direction along the first conductor 30 and the second conductor 31 is along the direction O, which is along a curve. In the antenna 15, the base 20, the first conductor 30, and the second conductor 31 are bent along the direction O, which is along a curve.

The antenna 15 is convexly curved toward a direction from the fourth conductor 50 toward the third conductor 40. For example, in the antenna 14, the direction from the fourth conductor 50 toward the third conductor 40 is along the direction P. The antenna 15 is convexly curved toward the direction P. In the antenna 15, the base 20, the third conductor 40, and the fourth conductor 50 are convexly curvable toward the direction P.

The radius of curvature of the antenna 15 in the third direction may be greater than the radius of curvature of the antenna 15 in the first direction. For example, as described above, the structure 5 has a spheroidal shape. Since the structure 5 has a spheroidal shape, the radius of curvature of the surface of the structure 5 in the direction N and the radius of curvature of the surface of the structure 5 in the direction O may be different depending on the location on the surface of the structure 5. The antenna 15 may be disposed in a region, within the surface of the structure 5, where the radius of curvature in the direction O is greater than the radius of curvature in the direction N. In the region, the first direction of the antenna 15 may be along the direction N, and the third direction thereof may be along the direction O. In such a configuration, the radius of curvature of the antenna 15 in the third direction may be greater than the radius of curvature of the antenna 14 in the first direction.

In a configuration in which the radius of curvature of the antenna 15 in the third direction is greater than the radius of curvature thereof in the first direction, the degree of deformation of each of the first conductor 30 and the second conductor 31 is reduced than in a configuration in which the radius of curvature of the antenna 15 in the third direction is the same as the radius of curvature thereof in the first direction. Such a configuration can enhance the robustness of the antenna 15, as with the antenna 12.

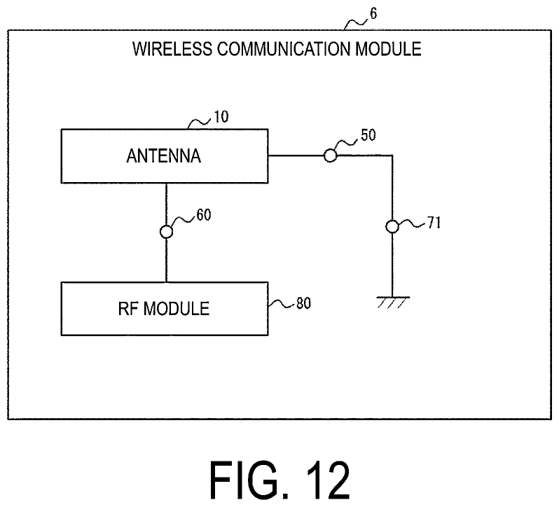

FIG. 12 is a block diagram of a wireless communication module 6 according to an embodiment of the present disclosure. FIG. 13 is a schematic configuration diagram of the wireless communication module 6 illustrated in FIG. 12.

The wireless communication module 6 includes the antenna 10, the circuit substrate 70, and an RF module 80. However, the wireless communication module 6 may include, instead of the antenna 10, any one of the antennas 11 to 15, the antenna 110, or the antenna 210.

As illustrated in FIG. 13, the antenna 10 is located above the circuit substrate 70. The feed line 60 of the antenna 10 is electrically connected via the circuit substrate 70 to the RF module 80 as are illustrated in FIG. 12. The fourth conductor 50 of the antenna 10 is electromagnetically connected to the ground conductor 71 included in the circuit substrate 70.

The circuit substrate 70 includes the ground conductor 71 and a resin substrate 72. In a case where the antenna 10 is located in any of the structures 1 to 5, the circuit substrate 70 may be bent as appropriate in accordance with the surface of each of the structures 1 to 5. The circuit substrate 70 may be configured as a flexible printed circuit.

The ground conductor 71 may include an electrically conductive material. The ground conductor 71 may extend on the XY plane. On the XY plane, the area of the ground conductor 71 is greater than the area of the fourth conductor 50 of the antenna 10. The length of the ground conductor 71 along the Y direction is greater than that of the fourth conductor 50 of the antenna 10 along the Y direction. The length of the ground conductor 71 along the X direction is greater than that of the fourth conductor 50 of the antenna 10 along the X direction. The antenna 10 may be located, in the X direction, on an end side of the center of the ground conductor 71. The center of the antenna 10 may be different, on the XY plane, from the center of the ground conductor 71. The location where the feed line 60 is electrically connected to the third conductor 40 of the antenna 10 may be different from the center of the ground conductor 71 on the XY plane.

When the antenna 10 resonates at a predetermined frequency, a loop electrical current may occur that flows in a loop shape through the first conductor 30, the second conductor 31, the third conductor 40, and the fourth conductor 50. Since the antenna 10 is located, in the X direction, on the end side of the center of the ground conductor 71, the current path flowing through the ground conductor 71 becomes asymmetric. Since the current path flowing through the ground conductor 71 is asymmetric, the antenna structure including the antenna 10 and the ground conductor 71 increases in polarization components in the Y direction of the radiation waves. An increase in the polarization components in the Y direction of the radiation waves can enhance the total radiation efficiency of the radiation waves.

The antenna 10 may be integrated with the circuit substrate 70. In a configuration in which the antenna 10 and the circuit substrate 70 are integrated, the fourth conductor 50 of the antenna 10 may be integrated with the ground conductor 71 of the circuit substrate 70.

The RF module 80 controls electrical power fed to the antenna 10. The RF module 80 modulates a baseband signal and supplies the resultant signal to the antenna 10. The RF module 80 modulates an electrical signal received by the antenna 10 into a baseband signal.

In the antenna 10, the variations of the resonant frequency by a conductor on a circuit substrate 70 side is small. The wireless communication module 6 including the antenna 10 may reduce the effect received from the external environment. Thus, the present embodiment can provide a novel wireless communication module 6.

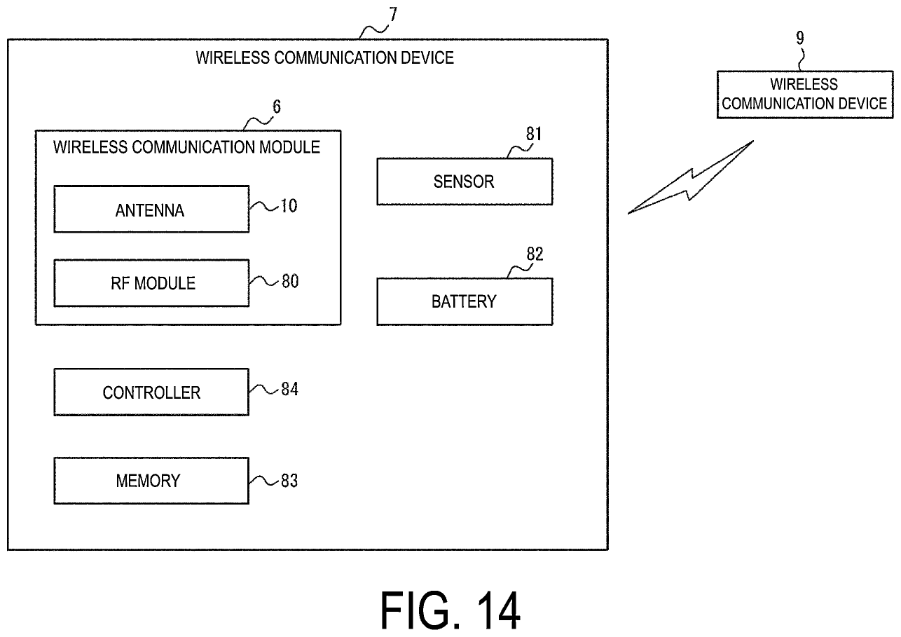

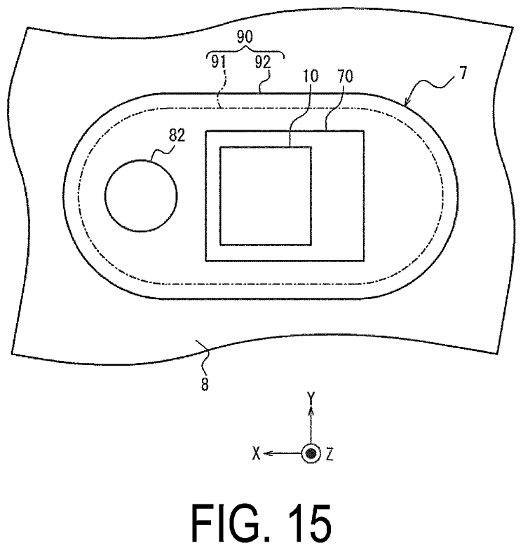

FIG. 14 is a block diagram of a wireless communication device 7 according to an embodiment of the present disclosure. FIG. 15 is a plan view of the wireless communication device 7 illustrated in FIG. 14. FIG. 16 is a cross-sectional view of the wireless communication device 7 illustrated in FIG. 14.

As illustrated in FIGS. 15 and 16, the wireless communication device 7 may be located on a structure 8. As illustrated in FIG. 14, the wireless communication device 7 may wirelessly communicate with a wireless communication device 9.

The structure 8 may be a conductive member. However, the structure 8 is not limited to a conductive member. The structure 8 may be any of the structures 1 to 5 in a case where the wireless communication device 7 includes any of the antennas 11 to 15 instead of the antenna 10.

The wireless communication device 9 may be a communication partner of the wireless communication device 7. The wireless communication device 9 may be any wireless communication device.

For example in a case where the structure 8 is the structure 1 as illustrated in FIG. 7, the wireless communication device 9 may be a server or the like. The server may be used by a business operator managing the structure 1, or the like.

For example, the wireless communication device 9 may be a smartphone in a case where the structure 8 is the structure 2 as illustrated in FIG. 8. The smartphone may be used by a guardian for a child using the structure 2, or the like.

For example in a case where the structure 8 is the structure 3 as illustrated in FIG. 9 and the structure 3 is used by an individual, the wireless communication device 9 may be a smartphone. The smartphone may be used by an individual using the structure 3. Furthermore, in a case where the structure 8 is the structure 3 and the structure 3 is used in a facility such as a library, the wireless communication device 9 may be a server. The server may be managed by a facility such as a library.

For example in a case where the structure 8 is the structure 4 as illustrated in FIG. 10, the wireless communication device 9 may be, for example, a server that may supply map information or the like. Furthermore, in a case where the structure 8 is the structure 4, the wireless communication device 9 may be a wireless communication device located in another rider helmet.

For example in a case where the structure 8 is the structure 5 as illustrated in FIG. 11, the wireless communication device 9 may be a server. The structure 5 may be used in a competition. In such a case, the server may be managed by an operator holding a competition, or the like.

As illustrated in FIG. 14, the wireless communication device 7 includes the wireless communication module 6, a sensor 81, a battery 82, a memory 83, and a controller 84. In a case where the structure 8 is the structure 4, the wireless communication device 7 may include a speaker and a display. The display of the wireless communication device 7 may be integrated with a goggle of the structure 4, which is a helmet. As illustrated in FIG. 15, the wireless communication device 7 may include a housing 90.

Examples of the sensor 81 may include a velocity sensor, a vibration sensor, an acceleration sensor, a gyroscopic sensor, a rotation angle sensor, an angular velocity sensor, a geomagnetic sensor, a magnet sensor, a temperature sensor, a humidity sensor, an air pressure sensor, an optical sensor, an luminance sensor, a UV sensor, a gas sensor, a gas concentration sensor, an atmosphere sensor, a level sensor, an odor sensor, a pressure sensor, a pneumatic pressure sensor, a contact sensor, a wind force sensor, an infrared sensor, a human detection sensor, a displacement sensor, an image sensor, a weight sensor, a smoke sensor, a leakage sensor, a vital sensor, a battery level sensor, an ultrasound sensor, a flow rate sensor, and a receiving device of a microphone or global positioning system (GPS) signal. The sensor 81 may obtain any information by at least some of these sensors. The sensor 81 may be at any location of the structure 8 in accordance with the information obtained.

For example in a case where the structure 8 is the structure 1 as illustrated in FIG. 7 and the structure 1 is installed outdoors, the sensor 81 may obtain environmental information on the surroundings of the structure 1. The environmental information may include at least any of a temperature obtained by the temperature sensor, a humidity obtained by the humidity sensor, an atmospheric pressure obtained by the air pressure sensor, and an luminance obtained by the luminance sensor.

For example in a case where the structure 8 is the structure 1 as illustrated in FIG. 7 and the structure 1 is part of a pipeline, the sensor 81 may obtain the flow rate of a fluid flowing through the pipeline. The flow rate may be obtained by the flow rate sensor.

For example in a case where the structure 8 is the structure 2 as illustrated in FIG. 8, the sensor 81 may obtain position information of the structure 2. For example in a case where the structure 8 is the structure 3 as illustrated in FIG. 9, the sensor 81 may obtain position information of the structure 3. The position information of the structure 2 and the position information of the structure 3 may be obtained by the receiving device of a GPS signal.

For example in a case where the structure 8 is the structure 4 as illustrated in FIG. 10, the sensor 81 may obtain position information of the structure 4, the position information being obtained by the receiving device of a GPS signal. As described above, the structure 4 may be mounted on the driver's head. The sensor 81 may obtain the driver's voice and the driver's vital information. The driver's voice may be collected by a microphone. The vital information may be obtained by the vital sensor. The vital information may include at least any of a respiration rate, a pulse rate, a blood pressure, a body temperature, and the like.

For example in a case where the structure 8 is the structure 5 as illustrated in FIG. 11, the sensor 81 may obtain: position information of the structure 5, the position information being obtained by the receiving device of a GPS signal; a velocity of the structure 5, the velocity being obtained by the velocity sensor; and the like.

The battery 82 supplies electrical power to the wireless communication module 6. The battery 82 may supply electrical power to at least one of the sensor 81, the memory 83, or the controller 84. The battery 82 may include either a primary battery or a secondary battery. The negative pole of the battery 82 may be electrically connected to the ground conductor 71 of the circuit substrate 70. The negative pole of the battery 82 may be electrically connected to the fourth conductor 50 of the antenna 10.

The memory 83 may include, for example, a semiconductor memory. The memory 83 may function as a working memory for the controller 84. The memory 83 may be included in the controller 84. The memory 83 stores programs describing processing contents for implementing the functions of the wireless communication device 7, information used for processing in the wireless communication device 7, and the like.

The controller 84 may include, for example, a processor. The controller 84 may include one or more processors. The processor may include a general-purpose processor that reads a specific program to execute a specific function, and a dedicated processor dedicated to a specific processing. The dedicated processor may include an application-specific IC. The application-specific IC is also referred to as an application specific integrated circuit (ASIC). The processor may include a programmable logic device. The programmable logic device is also called a programmable logic device (PLD). The PLD may include a field-programmable gate array (FPGA). The controller 84 may be either a system-on-a-chip (SoC) or a system in a package (SiP), which includes one or more processors cooperating with each other. The controller 84 may store various types of information, programs for causing the memory 83 to operate the components of the wireless communication device 7, and the like.

The controller 84 generates a transmission signal to be transmitted from the wireless communication device 7. The controller 84 may obtain information measured by the sensor 81. The controller 84 may generate a transmission signal corresponding to the information measured by the sensor 81. The controller 84 may transmit a transmission signal by the RF module 80 of the wireless communication module 6.

The controller 84 may receive a received signal from the wireless communication device 9 by the RF module 80 of the wireless communication module 6. The controller 84 may perform processing in accordance with the signal received.

For example in a case where the structure 8 is the structure 1 as illustrated in FIG. 7, the controller 84 may obtain environmental information on the surroundings of the structure 1 from the sensor 81. The controller 84 may generate a transmission signal corresponding to the environmental information obtained. The controller 84 may transmit a transmission signal corresponding to the environment information to the wireless communication device 9 by the RF module 80 of the wireless communication module 6. The wireless communication device 9 may obtain environment information on the surroundings of the structure 1 by receiving a signal corresponding to the transmission signal from the wireless communication device 7. The business operator or the like that manages the structure 1 can grasp the state of the environment around the structure 1 by analyzing the environmental information obtained by the wireless communication device 9.

For example in a case where the structure 8 is the structure 1 as illustrated in FIG. 7 and the structure 1 is part of a pipeline, the controller 84 may obtain the flow rate of a fluid flowing through the pipeline from the sensor 81. The controller 84 may generate a transmission signal corresponding to the flow rate obtained. The controller 84 may transmit the transmission signal corresponding to the flow rate to the wireless communication device 9 by the RF module 80 of the wireless communication module 6. The wireless communication device 9 may obtain information on the flow rate of the fluid flowing through the pipeline by receiving a signal corresponding to the transmission signal from the wireless communication device 7.

For example in a case where the structure 8 is the structure 2 as illustrated in FIG. 8 or the structure 3 as illustrated in FIG. 9, the controller 84 may obtain position information from the sensor 81. The controller 84 may generate a transmission signal corresponding to the position information obtained. The controller 84 may transmit the transmission signal corresponding to the position information to the wireless communication device 9 by the RF module 80 of the wireless communication module 6. The wireless communication device 9 may obtain position information of the structure 2 by receiving a signal corresponding to the transmission signal from the wireless communication device 7. In a case where the structure 8 is the structure 2, the wireless communication device 9 can obtain the position information of the structure 2, and the guardian can thereby confirm the whereabouts of the child who uses the structure 2. In a case where the structure 8 is the structure 3, the wireless communication device 9 can obtain position information of the structure 3, and the individual using the structure 3 and/or the facility managing the structure 3 can thereby confirm the position of the structure 3.

For example in a case where the structure 8 is the structure 4 as illustrated in FIG. 10, the controller 84 may obtain position information of the structure 4 and vital information of the driver from the sensor 81. The controller 84 may generate a transmission signal corresponding to the position information and the vital information that have been obtained. The controller 84 may transmit the transmission signal corresponding to the position information and the vital information to the wireless communication device 9 by the RF module 80 of the wireless communication module 6. The wireless communication device 9 may obtain the position information of the structure 4 and the vital information of the driver by receiving a signal corresponding to the transmission signal from the wireless communication device 7.

For example in a case where the structure 8 is the structure 4 as illustrated in FIG. 10, the controller 84 may obtain the driver's voice from the sensor 81. The controller 84 may generate a transmission signal corresponding to the driver's voice obtained. The controller 84 may transmit the transmission signal corresponding to the voice to the wireless communication device 9 by the RF module 80 of the wireless communication module 6. The wireless communication device 9 may obtain the driver's voice by receiving a signal corresponding to the transmission signal from the wireless communication device 7. In a case where the wireless communication device 9 is a wireless communication device located in another rider helmet, the wireless communication device 9 outputs, from a speaker, the voice obtained from the wireless communication device 7. Further, in a case where the wireless communication device 9 is a wireless communication device located in another rider helmet, the controller 84 may obtain, from the wireless communication device 9, a signal corresponding to the other driver's voice by the RF module 80 of the wireless communication module 6. The controller 84 may output, from the speaker of the wireless communication device 9, the other driver's voice obtained. Such a configuration allows the driver wearing the structure 4 and the other driver to have a conversation.

For example in a case where the structure 8 is the structure 4 as illustrated in FIG. 10, the controller 84 may obtain map information from the wireless communication device 9 by the RF module 80 of the wireless communication module 6. In such a case, the wireless communication device 9 may be a server. The controller 84 may display the map information obtained on a display.

For example in a case where the structure 8 is the structure 5 as illustrated in FIG. 11, the controller 84 may obtain position information and velocity of the structure 5 from the sensor 81. The controller 84 may generate a transmission signal corresponding to the position information and velocity obtained. The controller 84 may transmit the transmission signal corresponding to the position information and velocity to the wireless communication device 9 by the RF module 80 of the wireless communication module 6. The wireless communication device 9 may obtain the position information and velocity of the structure 5 by receiving a signal corresponding to the transmission signal from the wireless communication device 7. As described above, the wireless communication device 9 may be used by an operator holding a competition, or the like. The operator may analyze the content of the competition in which the structure 5 is used, based on the position information and velocity of the structure 5 obtained by the wireless communication device 9.

As illustrated in FIG. 15, the housing 90 protects other devices of the wireless communication device 7. The housing 90 may include the first housing 91 and a second housing 92.

As illustrated in FIG. 16, the first housing 91 supports other devices. The first housing 91 may extend along the XY plane. However, in a case where the structure 8 is any of the structures 1 to 5, the first housing 91 may be bent along the surface of any of the structures 1 to 5.

The first housing 91 may support the wireless communication device 7. The wireless communication device 7 is located on an upper surface 91a of the first housing 91. The first housing 91 may support the battery 82. The battery 82 is located on the upper surface 91a of the first housing 91. On the upper surface 91a of the first housing 91, the wireless communication module 6 and the battery 82 may be disposed side by side along the Y direction. The second conductor 31 of the antenna 10 is located between the battery 82 and the third conductor 40 of the antenna 10. The battery 82 is located on a side facing the second conductor 31 when viewed from the third conductor 40 of the antenna 10.

The second housing 92 may cover other devices. The second housing 92 includes a lower surface 92a located on the Z axis positive direction side of the antenna 10. The lower surface 92a extends along the XY plane. The lower surface 92a is not limited to a flat surface, and may include recesses and protrusions. The second housing 92 may include a conductive member 93. The conductive member 93 may be located on the lower surface 92a of the second housing 92. The conductive member 93 is located in at least one of three places: inside of, on an outer side of, or on an inner side of the second housing 92. The conductive member 93 is located either on an upper surface or on a side surface of the second housing 92.

The conductive member 93 faces the antenna 10. The antenna 10 is coupled to the conductive member 93 and can emit electromagnetic waves by using the conductive member 93 as a secondary radiator. The antenna 10 and the conductive member 93 facing each other may result in a large capacitive coupling between the antenna 10 and the conductive member 93. The current direction of the antenna 10 being along a direction in which the conductive member 93 extends may result in a large electromagnetic coupling between the antenna 10 and the conductive member 93. This coupling may function as mutual inductance.

The configurations according to the present disclosure are not limited only to the embodiments described above, and may be modified in various ways. For example, the functions and the like included in the components and the like can be repositioned, provided that logical inconsistencies are avoided, and a plurality of the components and the like can be combined into one or divided.

The drawings for describing the configurations according to the present disclosure are schematic. The dimensional proportions and the like in the drawings do not necessarily coincide with the actual values.

In the present disclosure, the terms “first”, “second”, “third”, and the like are each an example of an identifier for distinguishing a particular configuration. Configurations distinguished by the terms “first”, “second”, and the like in the present disclosure can exchange the numbers in the configurations with each other. For example, the first conductor and the second conductor may exchange the identifiers “first” and “second” with each other. The identifiers are interchanged simultaneously. The configurations are distinguished even after the identifiers are interchanged. The identifiers may be deleted. Configurations with identifiers deleted are distinguished by reference signs. No interpretation on the order of the configurations, no grounds for the presence of an identifier of a lower value, and no grounds for the presence of an identifier of a higher value shall be given based solely on the description of identifiers such as “first” and “second” in the present disclosure.

### REFERENCE SIGNS LIST

1, 2, 3, 4, 5, 8 Structure
2A Cover
2B Body portion
2C, 2D End portion
2E Region
3A Spine
3B, 3C Connection portion
3D, 3E Cover portion
3D1, 3D2, 3E1, 3E2 End portion
4A Curved surface region
6 Wireless communication module
7, 9 Wireless communication device
10, 11, 12, 13, 14, 15, 110, 210 Antenna
30, 230 First conductor
31, 231 Second conductor
32 First connection conductor
33 Second connection conductor
40, 140 Third conductor
41, 141 Fifth conductor
42, 142 Sixth conductor
43 Seventh conductor
50, 250 Fourth conductor
60, 260 Feed line
70 Circuit substrate
71 Ground conductor
72 Resin substrate
80 RF module
81 Sensor
82 Battery
83 Memory
84 Controller
90 Housing
91 First housing
91a Upper surface
92 Second housing
92a Lower surface
93 Conductive member
20 Base
21 Upper surface
22 Lower surface
250A Opening

1. An antenna comprising:
a first conductor,
a second conductor facing the first conductor in a first direction,
a third conductor along the first direction, the third conductor being located between the first conductor and the second conductor and configured to capacitively connect the first conductor and the second conductor,
a fourth conductor along the first direction, the fourth conductor being separated from the third conductor in a second direction intersecting the first direction and electrically connected to the first conductor and the second conductor, and
a feed line configured to be electromagnetically connected to the third conductor,
the antenna being configured to be bending deformable in cross-sectional views along the first direction and the second direction.

2. The antenna according to claim 1, wherein
the third conductor comprises a fifth conductor electrically connected to the first conductor and a sixth conductor electrically connected to the second conductor, and
the fifth conductor and the sixth conductor are configured to be capacitively connected to each other.

3. The antenna according to claim 2, wherein
the third conductor further comprises a seventh conductor, and
the seventh conductor is separated from the fifth conductor and the sixth conductor in the second direction, and is configured to capacitively connect the fifth conductor and the sixth conductor.

4. The antenna according to claim 2, wherein
the first conductor comprises at least one first connection conductor extending along the second direction from the fourth conductor to the fifth conductor, and
the second conductor comprises at least one second connection conductor extending along the second direction from the fourth conductor to the sixth conductor.

5. The antenna according to claim 1, wherein the antenna is configured to be bending deformable in cross-sectional views along a third direction intersecting a first plane, the first plane comprising the first direction and the second direction, and along the second direction.

6. The antenna according to claim 1, wherein the antenna is configured to be convexly curvable toward a direction from the fourth conductor toward the third conductor.

7. An antenna comprising:
a first conductor,
a second conductor facing the first conductor in a first direction,
a third conductor along the first direction, the third conductor being located between the first conductor and the second conductor and configured to capacitively connect the first conductor and the second conductor,
a fourth conductor along the first direction, the fourth conductor being separated from the third conductor in a second direction intersecting the first direction and electrically connected to the first conductor and the second conductor, and
a feed line configured to be electromagnetically connected to the third conductor,
the first direction being along a curve.

8. The antenna according to claim 7, wherein
the third conductor comprises a fifth conductor electrically connected to the first conductor and a sixth conductor electrically connected to the second conductor, and
the fifth conductor and the sixth conductor are configured to be capacitively connected to each other.

9. The antenna according to claim 8, wherein
the third conductor further comprises a seventh conductor, and
the seventh conductor is separated from the fifth conductor and the sixth conductor in the second direction, and is configured to capacitively connect the fifth conductor and the sixth conductor.

10. The antenna according to claim 8, wherein
the first conductor comprises at least one first connection conductor extending along the second direction from the fourth conductor to the fifth conductor, and
the second conductor comprises at least one second connection conductor extending along the second direction from the fourth conductor to the sixth conductor.

11. The antenna according to claim 7, wherein a third direction intersecting a first plane, the first plane comprising the first direction and the second direction, is along a curve.

12. The antenna according to claim 11, wherein the antenna is convexly curved toward a direction from the fourth conductor toward the third conductor.

13. The antenna according to claim 11, wherein a radius of curvature of the antenna in the third direction is greater than a radius of curvature of the antenna in the first direction.

14. A wireless communication module, comprising:
the antenna according to claim 1, and
an RF module electrically connected to the feed line.

15. A wireless communication device, comprising:
the wireless communication module according to claim 14, and
a battery configured to supply electrical power to the wireless communication module.
